(19) United States
(12) Patent Application Publication
(10) Pub. No.: US 2011/0168212 A1
(43) Pub. Date: Jul. 14, 2011

(54) WAFER STACK CLEANING

(75) Inventors: Per Arne Wang, Porsgrunn (NO); Arne Ramsland, Royse (NO); Ole Christian Tronrud, Sokna (NO); Erik Hjertaas, Sylling (NO); Bent Hammel, Oslo (NO); André Skeie, Honefoss (NO); Ola Tronrud, Royse (NO)

(73) Assignee: REC ScanWafer AS, Porsgrunn (NO)

(21) Appl. No.: 12/812,925

(22) PCT Filed: Jan. 15, 2009
(86) PCT No.: PCT/NO09/00019

§ 371 Date: Mar. 22, 2011

(30) Foreign Application Priority Data
Jan. 15, 2008 (DE) 102008004548.9

(51) Int. Cl. B08B 3/02

(52) U.S. Cl. 134/34; 134/198

(57) ABSTRACT

The invention comprises a device and method for surface cleaning of individual wafers or substrates arranged in a stack along a stacking direction, where a jet of fluid is sent towards the stack in a direction perpendicular to the stacking direction and it is provided a relative movement between the wafer stack and the nozzle in the stacking direction.

The present invention is related to the process of solar cell manufacturing, and more specifically to production of wafers cut out from a silicon ingot.

In the solar cell industry it is a goal to be able to produce and handle thin wafers as this will result in reduced material consumption and manufacturing costs. Solar cell wafers have thus a thickness lying between 100 μm and 300 μm.

Wafers are normally manufactured by cutting a silicon ingot into slices. Before cutting, an adhesive layer is deposited on one surface of the ingot with the purpose of holding the wafers in place during cutting. After cutting/slicing, a stack of wafers is provided, where the individual wafers have a large amount of cutting fluid (slurry) on the surface. This fluid contributes to sticking between the wafers. The cut wafers must be washed (removal of slurry, precleaning) and the adhesive layer and related chemicals must be removed in order to provide wafers of the required solar cell quality (after removal of the adhesive layer, a stack of wafers is provided). To achieve this, one often has to singulate the wafers and then clean them individually (final cleaning) in the final wafer process.

Currently, solar cell wafers are cleaned in a stack or individually, for instance in a so-called horizontal line. In stack cleaning, the fluid will normally not penetrate the stack and the wafer surface will normally not be exposed to the fluid and the required chemicals. In horizontal cleaning one has to separate the wafers in a wet condition, which causes high breakage rates because of the capillary forces between the wafers.

WO 97/02905 describes a method and apparatus for washing a silicon ingot with water to remove particulate matter. This apparatus is meant for wafers with a certain thickness, e.g. 800 μm. This apparatus comprises nozzles adapted to deliver jets of water against the ingot for flushing particulate matter from the ingot. A carrying device mounts the nozzles for movement longitudinally back and forth over substantially the full length of the ingot. During the flushing process, the ingot is held by holder arms. This publication relates to handling of wafers for the electronics industry. Electronic industry wafers have better mechanical properties than solar cell wafers, and they can stand relatively high mechanical stress among other things because they are thick (300-900 μm). Solar cell wafers on the contrary are very fragile and weak and must be handled more carefully.

During washing of thin wafers mechanical stress which can lead to breakage has to be avoided.

The invention provides a method and a device for cleaning a stack of wafers or substrates, where the single wafers are held together by water, slurry and chemical products. The invention permits to perform a substantially complete cleaning of the wafers before separation takes place. If a block drying method is available (that is a drying process where the wafers still are arranged close to one another), this invention also provides a method of avoiding the wet singulation process (the wet singulation process being necessary to ensure cleaning of the individual wafers, which normally is labour consuming and stresses the material substantially, and introduces breakage).

The device according to the invention comprises at least one nozzle arranged to send a jet of fluid towards the stack in a direction perpendicular to the stacking direction. The device is further arranged to provide a relative movement between the wafer stack and the nozzle in the stacking direction. The device comprises also a fluid container such that the stack is immersed in a fluid during washing.

When the stack is immersed in fluid, capillary forces actuating between wafers are avoided. At the same time the fluid and fluid currents contribute to stabilise the wafers mechanically. The term stabilising refers to the wafers being still in the fluid current that is vibration movements of the wafers are avoided. This is performed without the need of supporting elements as the support function is performed by the fluid jets. In this way unwanted mechanical and dynamic stress is highly reduced. The fluid will contribute with its viscous dampening and pressure stabilisation because fluid is present on both sides of the wafer. Tests have shown that with an optimal nozzle pressure the wafers will stand vertically in the fluid current practically without vibrations or other movements and at the same time the distance between wafers will be sufficient to provide cleaning.

The method according to the invention comprises the step of sending a jet of fluid towards the stack in a direction perpendicular to the stacking direction and moving the wafer stack and the nozzle relative to one another in the stacking direction. The wafer stack is immersed in fluid.

The expression “stacking direction” in the context of the present application refers to the direction along which the wafers in a stack are piled together. This direction is substantially perpendicular to the plane of the single wafers.

The term “stack” is used to indicate a pile of wafers independently of the wafers being held together by an adhesive or not.

The relative movement provides wafer-by-wafer (step-by step) separation and cleaning, until the whole stack is cleaned.

The invention provides an action which has one component in the stacking direction (providing separation) and one component in the plane of the wafers (providing cleaning). As mentioned before, the jets of water together with the water environment provide stabilisation of the wafers. Opening the stack permits cleaning the wafers' surface as will be explained below. The jet of water provides separation of the wafers, that is, an increase of the distance between wafers from approximately (usually less than) 100 μm (almost completely collapsed stack) to a distance in the range of 400 to 2000 μm. This leads to fluid flow between wafers and cleaning (washing) of the wafer surfaces which are exposed to washing fluid by opening of the stack. A distance between wafers of 100 μm (or less) will not allow flow of washing fluid between the wafers. The process according to the invention takes place under water or another liquid and leads to a stable opening between wafers of between 400 and 2000 μm (with a most probable value around 800 μm). The jets of water and the relative movement together achieve this object. This process must not be confused with wafer singulation, as the wafers are not taken away from the stack but washed while being arranged in the stack.

The invention can be used for pre-cleaning and final cleaning of wafers. During pre-cleaning the wafers in the stack are held together by means of adhesive, while in the final cleaning process the adhesive has been removed. A cleaning/stack opening method will then comprise the following steps: 1) pre-cleaning, 2) removal of adhesive layer, 3) cleaning/opening of the stack (according to the invention), 4) drying, 5) dry singulation. Steps 4) and 5) can be replaced by other procedures providing singulation (e.g. singulation in fluid bath) and drying. Another alternative can comprise use of the invention both in the final cleaning and in the pre-cleaning process. This alternative will then comprise among others the following steps: 1) pre-cleaning/opening of the stack (according to the invention), 2) removal of adhesive layer, 3) final cleaning/opening of the stack (according to the invention), 4) drying, 5) dry singulation.

As mentioned before, during pre-cleaning the wafers are held together by means of an adhesive layer (the adhesive layer being normally fastened to the upper edge of the wafers so that the wafers “hang” from the adhesive layer). The adhesive layer ensures a distance (100-300 μm) between the adhered edges of the wafers. As a consequence of this, separation is facilitated on one wafer edge, and vibration of the single wafers is highly limited (by fixation of the opposite edge). This permits controlled opening of the stack in case the invention is used in this phase of the process. During cleaning (final cleaning) it can be necessary to provide controlled friction against the wafers lower edges (for horizontal stacks) to achieve such a controlled opening, since there is no adhesive on the edge. In the latter case, it can also be necessary to use some mechanical support on the ends of the stack, in order to keep the stack and the individual wafers in position.

In an embodiment the cleaning process is performed with the nozzles immersed in a fluid bath. It is also possible to provide fluid jets in the fluid by means of nozzles which are not submerged but which have an opening near the water surface.

In an embodiment of the invention several nozzles are arranged to provide a fluid jet with a surface parallel to the wafer's surface.

The stacking direction in one embodiment of the invention is horizontal and the fluid jet(s) does not have to overcome gravitational forces which press the wafers together.

The invention has so far been described as comprising two actions: sending a jet of fluid towards the stack and moving the stack or the jet of fluid along the stacking direction. Said actions can be performed simultaneously and continuously or with pauses (combinations of non-simultaneous actions with continuous actions are also possible in limited periods of time). According to this it is possible to “pause” the movement along the stacking direction to ensure that opening of the stack and cleaning of the wafers takes place and thereafter moving to the next location. It is also possible to combine these two movements in a sequence starting e.g. with a “paused” movement and finishing with a continuous movement. The invention provides sequential opening of the stack, starting from one end of the stack and opening it between adjacent wafers which are thus cleaned individually.

The invention will now be explained by means of example embodiments shown in the drawings, where:

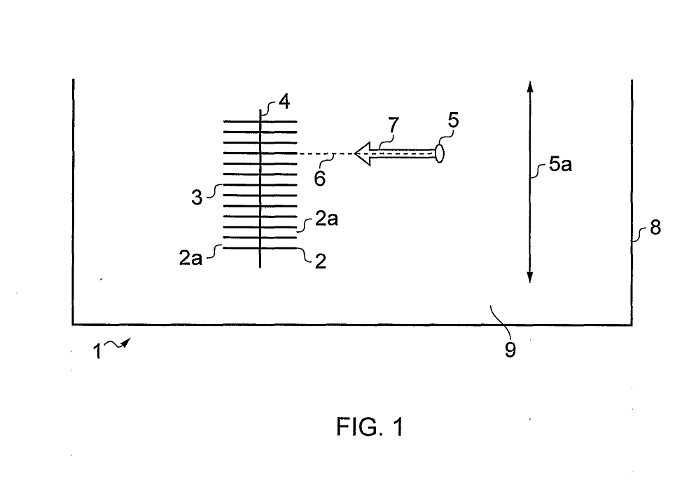

FIG. 1 shows a first embodiment of the invention.

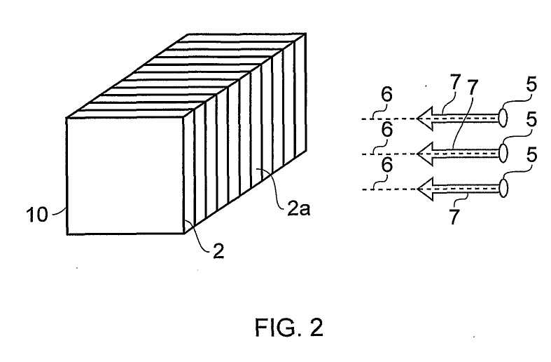

FIG. 2 shows a second embodiment of the invention.

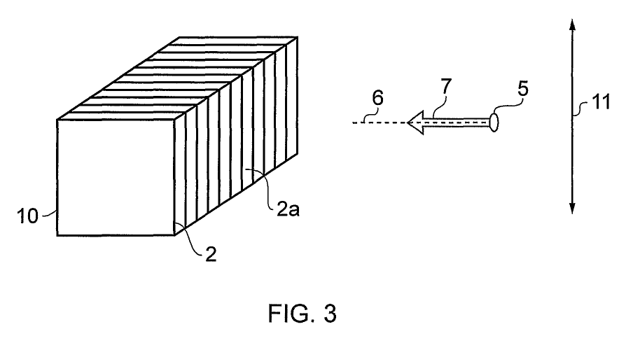

FIG. 3 shows a third embodiment of the invention.

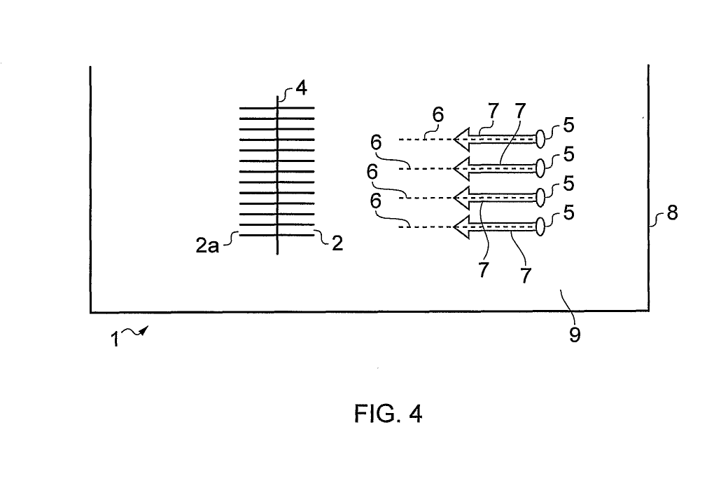

FIG. 4 shows a fourth embodiment of the invention.

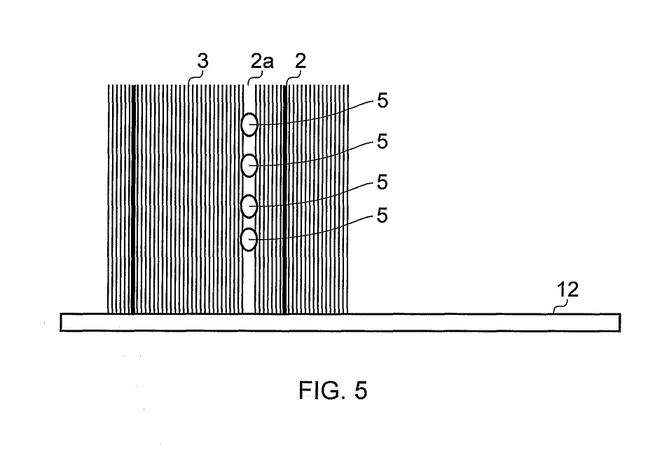

FIG. 5 shows a fifth embodiment of the invention.

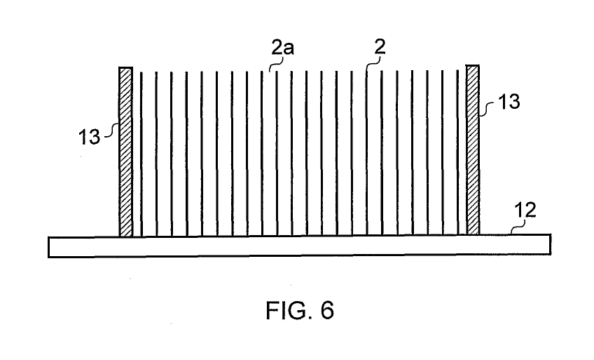

FIG. 6 shows an embodiment of the invention where support bodies are arranged by each end of the stack.

FIG. 1 shows a first embodiment of the invention. A device 1 is arranged for separation and cleaning of wafers 2 arranged in a stack 3 along a stacking direction 4. Device 1 comprises at least one nozzle 5 arranged to send a jet 6 of fluid towards stack 3 in a direction 7 perpendicular to the stacking direction 4. Device 1 is also arranged to provide a relative movement between the wafer stack 3 and the nozzle 5 in the stacking direction 4. This relative movement can be implemented by movement of both the stack and the nozzle, or by movement of only one of these elements. Said movement's speed must be chosen carefully to achieve opening of the wafer stack by separation of the wafers from one another and cleaning of the wafers' surface. The process will e.g. take between 1 and 10 minutes for a stack, and it is possible to perform several passes of the fluid jet back and forth along the stack. It is also possible to “pause” the movement as mentioned above.

Stacking direction 4 can be horizontal or vertical. The force necessary for separating the wafers will be greater in the case of a vertical stack.

Device 1 comprises a container 8 with fluid 9, so that the method according to the invention is performed within a fluid. Fluid sent by nozzle 5 can be water (temperated or not), ultra clean water, water with additives (cleaning substances). It is possible to use different fluids for the container and the jet of fluid with e.g. different concentration of cleaning fluids.

FIG. 2 shows a second embodiment of the invention, where three nozzles 5 are situated substantially in a common plane perpendicular to the stacking direction 4. This plane coincides with the surface 10 of wafer 2.

FIG. 3 shows a third embodiment of the invention, where a single nozzle 5 moves up and down along a direction 11 perpendicular to the stacking and relative movement direction 4. In this way a wafer is flushed in most of its surface by means of a single fluid jet.

Although FIGS. 2 and 3 do not show a container and a fluid as shown in FIG. 1, it is assumed that these embodiments of the invention comprise such a fluid filled container.

FIG. 4 shows an embodiment of the invention where several nozzles 5 are arranged at different positions along the stacking direction 4. This figure is a view from above, and it is possible to combine this embodiment with the embodiment shown in FIG. 3 so that several nozzles are situated at each position marked with 5 or with the embodiment shown in FIG. 2.

As mentioned before, for pre-cleaning the wafer stack shown in FIGS. 1-5 will comprise a layer of adhesive (not shown) situated on the upper surface of the stack.

FIG. 5 shows an embodiment of the invention where a support in the form of a plate 12 is situated under the stack 3 to provide friction against the wafers' lower edges and achieve a controlled opening of the stack. Support 12 can be employed in all the embodiments of the invention previously described, replacing the adhesive layer. Support 12 can be implemented as one or several rods, beams, wires, wire meshes, etc.

FIG. 6 shows support bodies 13 arranged by each end of the stack 3. The aim of these bodies is to help provide controlled movement of the stack during separation. Support bodies 13 can also be used in the pre-cleaning phase where wafers are held together by an adhesive.

Although the invention is described for use in cleaning of solar cell wafers it is also envisaged its use in cleaning of other types of wafers, as e.g. in the electronics industry.

1.-11. (canceled)

12. A device arranged for surface cleaning of solar cell wafers with thickness lying between 100 μm and 300 μm and stacked along a stacking direction comprising at least one nozzle, the device being arranged to provide a relative movement between the wafer stack and the nozzle in the stacking direction,
wherein the device comprises a fluid container and the stack of wafers is immersed in the fluid in the fluid container, and
the at least one nozzle is immersed in the fluid in the fluid container and arranged to send a jet of fluid towards the stack in a direction perpendicular to the stacking direction.

13. The device according to claim 12, wherein the device comprises two or more nozzles situated substantially in a common plane perpendicular to the stacking direction.

14. The device according to claim 13, wherein the device comprises nozzles situated in several planes perpendicular to the stacking direction.

15. The device according to claim 12, wherein the stack is held together along one edge by means of an adhesive layer.

16. A method for surface cleaning of wafers or substrates, the wafers or substrates having a thickness lying between 100 μm and 300 μm and being stacked along a stacking direction, providing a relative movement between the wafer stack and the nozzle in the stacking direction, said method further comprising the steps of:
immersing the stack of wafers in a fluid; and
sending a jet of the fluid by means of at least one immersed nozzle towards the stack in a direction perpendicular to the stacking direction.

17. The method according to claim 16, further comprising the step of sending two or more jets of fluid towards the stack, where the jets of fluid are situated substantially in a common plane perpendicular to the stacking direction.

18. The method according to claim 17, further comprising the step of sending jets of fluid situated substantially in several planes perpendicular to the stacking direction.

19. The method according to claim 16, wherein the method is performed on a stack provided with an adhesive layer along one edge of the stack.

20. The method according to claim 19, further comprising the step of removing the adhesive layer.
